(19) United States
(12) Patent Application Publication
(10) Pub. No.: US 2020/0197989 A1
(43) Pub. Date: Jun. 25, 2020

(54) Flush Station

(71) Applicant: DPFSource LLC, Morrison, CO (US)

(72) Inventor: Junior Reyes, Morrison, CO (US)

(21) Appl. No.: 16/718,452

(22) Filed: Dec. 18, 2019

Related U.S. Application Data
(60) Provisional application No. 62/781,975, filed on Dec. 19, 2018.

(51) Int. Cl. B08B 9/08; B01D 41/04; B01D 21/02

(52) U.S. Cl. CPC B08B 9/0813; B01D 41/04; B01D 46/2418; B08B 2215/00; B01D 21/02

(57) ABSTRACT

An example flush station includes an upper cabinet and a lower cabinet. At least one cleaning head is mounted in the upper cabinet, and has an anchoring attachment, a cleaning solution inlet to dispense cleaning solution, and a compressed air inlet to dispense compressed air. A vacuum system may be provided in the upper cabinet to entrain airborne particulates. A catch basin formed in the lower cabinet receives spent cleaning solution from the upper cabinet. At least one settling tank in the lower cabinet receives spent cleaning solution from the catch basin for settling at least some suspended particulate matter in the spent cleaning solution. A grate at an interface between the upper section and the lower cabinet provides a cleaning deck for filters and/or other components to be cleaned during the cleaning operation. During the cleaning operation, cleaning solution and/or compressed air are dispensed through the filters and/or other components.

### CROSS REFERENCE TO RELATED APPLICATION

This application claims the priority benefit of U.S. Provisional Patent Application No. 62/781,975 filed Dec. 19, 2018 for “Diesel Particulate Filter Flush Station With Flow Bench And Drying Table” of Junior Reyes, hereby incorporated by reference for all that is disclosed as though fully set forth herein.

### BACKGROUND

Silicon carbide (SiC) and cordierite substrate ceramic filters are used for example as diesel particulate filters (DPFs). DPFs are particulate filters in diesel engine exhaust systems that capture smoke particles such as ash and soot before these exit the exhaust into the atmosphere. Silicon carbide and cordierite show substantial resistance to corrosion, high temperatures, and thermal shocks, and have a low coefficient of thermal expansion. However, other types of DPFs now known or later developed are also referred to herein under the umbrella term “DPF.” As airflow through the DPF drops with the increasing presence of captured particulates, DPFs can be cleaned and reused, reducing the impact on the environment and waste disposal.

In high temperature environments, such as during regular use in diesel engines, the ash and soot on the DPF may become hardened and difficult to remove with traditional cleaning techniques. Traditional cleaning techniques involve pneumatic cleaning, followed by baking, and are believed to remove less than 35% of accumulated ash and soot. This only results in an improvement of airflow of less than 35%, meaning that the DPF has to be cleaned even more frequently the more it has been reused.

### BRIEF DESCRIPTION OF THE DRAWINGS

FIG. 1 is a perspective view of an example flush station.

FIG. 2 is a top-down perspective view of a lower cabinet of the example flush station.

FIG. 3 is a close-up perspective view of an upper cabinet of the example flush station.

FIG. 4 is a close-up view of an example cleaning head which may be mounted in the upper cabinet of the example flush station.

FIG. 5 is another view of the upper cabinet of the example flush station shown in FIG. 3, illustrating filters to be cleaned.

FIG. 6 is a perspective view of an example flow bench which may be implemented with the flush station.

FIG. 7 is a perspective view of an example drying table which may be implemented with the flush station.

### DETAILED DESCRIPTION

A need exists for more efficient and effective cleaning techniques for DPFs (and other filters) in order to prolong the operational lifetime of the filters, increase operating efficiencies, and decrease waste and associated costs. The flush station disclosed herein may help prevent premature failure, increase operating efficiencies, and decrease waste and associated costs, by removing hardened ash, soot and/or other contaminants from the filters.

An example flush station includes an upper cabinet and a lower cabinet. At least one cleaning head is mounted in the upper cabinet, and has an anchoring attachment, a cleaning solution inlet to dispense cleaning solution, and a compressed air inlet to dispense compressed air. A catch basin formed in the lower cabinet receives spent cleaning solution from the upper cabinet.

At least one settling tank in the lower cabinet receives spent cleaning solution from the catch basin for settling at least some suspended particulate matter in the spent cleaning solution. Settling tanks help remove the soot and ash (e.g., by settling down at the bottom of the tank). This helps keeps the cleaning solution (e.g., flush water) cleaner for a longer time.

A grate at an interface between the upper section and the lower cabinet provides a cleaning deck for filters and/or other components to be cleaned during the cleaning operation. During the cleaning operation, cleaning solution and/or compressed air are dispensed through the filters and/or other components.

In an example, the flush station may include a removable top cabinet for servicing the bottom tank; a clear sealing deck for visual inspection; a remote connection to start/stop and/or monitor the cleaning operation without the user being present; fully adjustable flow of cleaning solution; adjustable purge time; adjustable dwell times; adjustable flush time; adjustable drying times; and spent cleaning solution filtration.

The example flush station disclosed herein is described for purposes of illustration as it may be implemented to clean silicon carbide and cordierite honeycomb flow through media. It is noted that, while the flush station is described herein for purposes of illustration as it may be implemented as such to clean DPFs, the flush station may be implemented to clean and restore any of a wide variety of other types of reusable filters and is not limited only to use with DPFs.

In another example, the flush station may be implemented to service any of a wide variety of emissions components and other filtration components, for near, or even in some cases, complete restoration of the filter. Other example filters include, but are not limited to, EGR coolers and radiators, and charge air coolers, Selective Catalytic Reduction (SCR) flow-through catalysts, and diesel oxidation catalysts. To the extent that the flush station herein should be modified for application with different filter types, those modifications would fall well within the scope of those having ordinary skill in the art to implement, after becoming familiar with the teachings herein, and thus are intended to form a part of this disclosure.

Before continuing, it is noted that as used herein, the terms “includes” and “including” mean, but is not limited to, “includes” or “including” and “includes at least” or “including at least” The term “based on” means “based on” and “based at least in part on.”

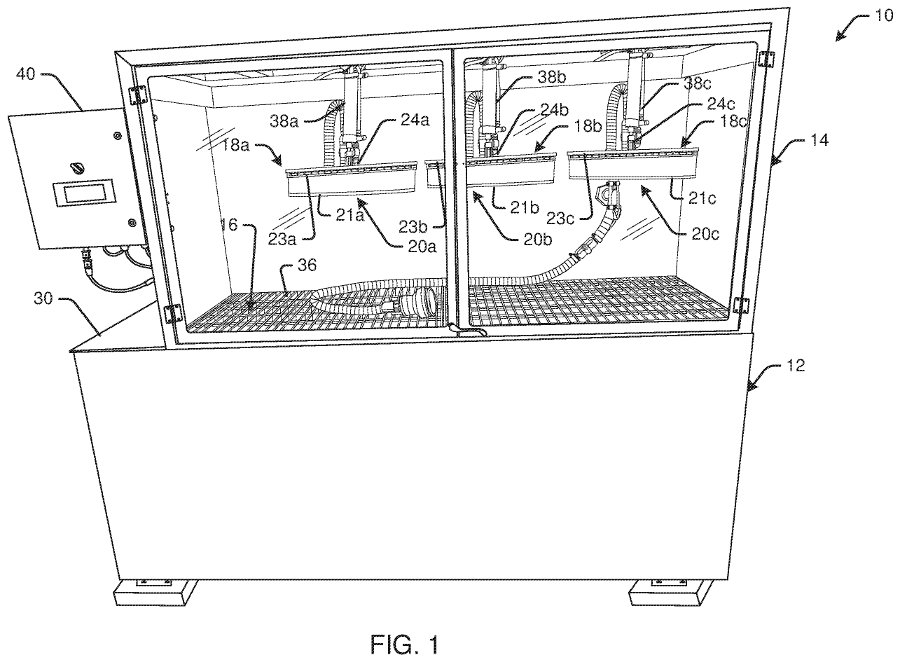

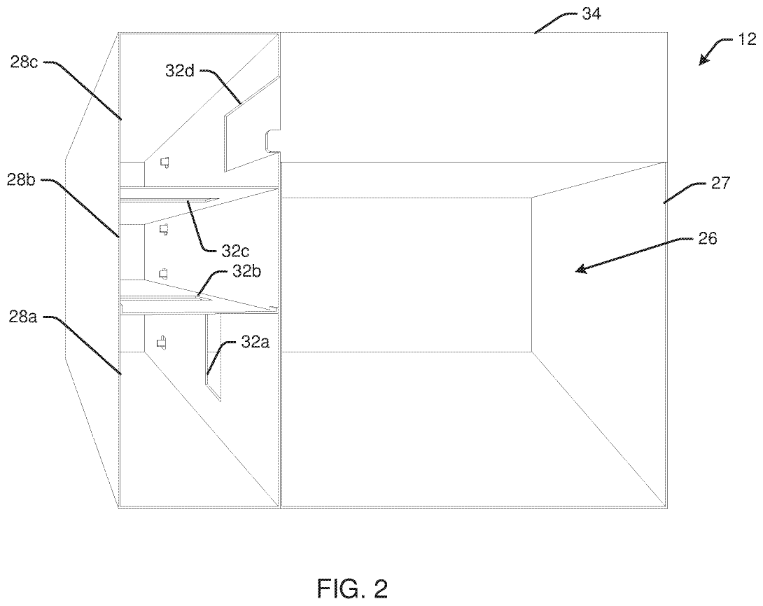

FIG. 1 is a perspective view of an example flush station 10. FIG. 2 is a top-down perspective view of a lower cabinet 12 of the example flush station 10. The example flush station 10 includes a grate 36 provided at an interface between the opening formed through the lower section of the upper cabinet and the upper section of the lower cabinet, the grate providing a cleaning deck to receive filters and/or other components to be cleaned.

The terms “upper” and “lower” are intended to be illustrative of particular examples of the flush station 10, and a reader of ordinary skill in the art, after becoming familiar with the teachings herein, will understand that the housings and tanks could take different configurations without departing from the spirit or function of the disclosure herein.

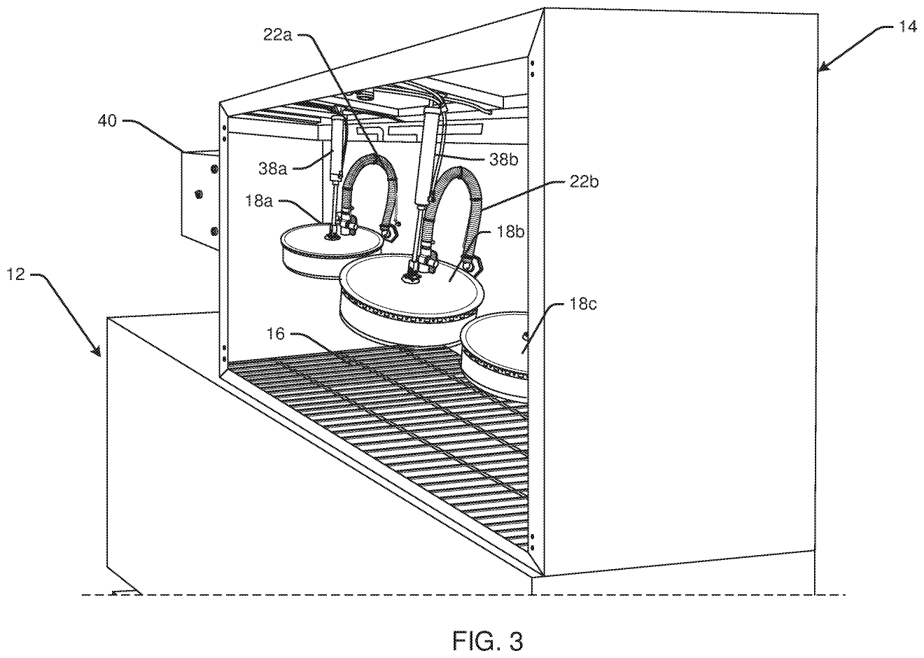

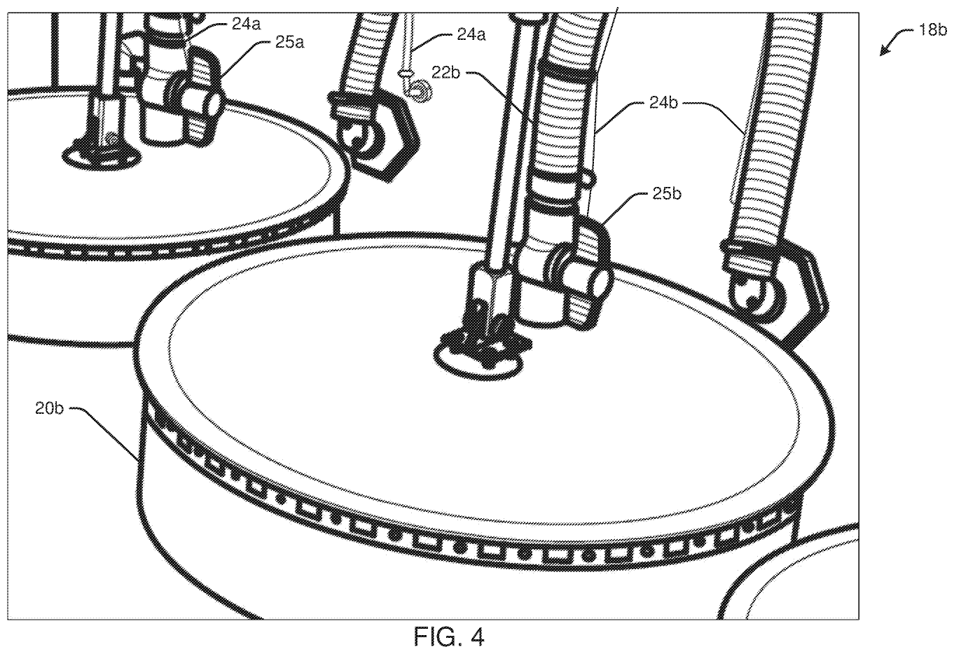

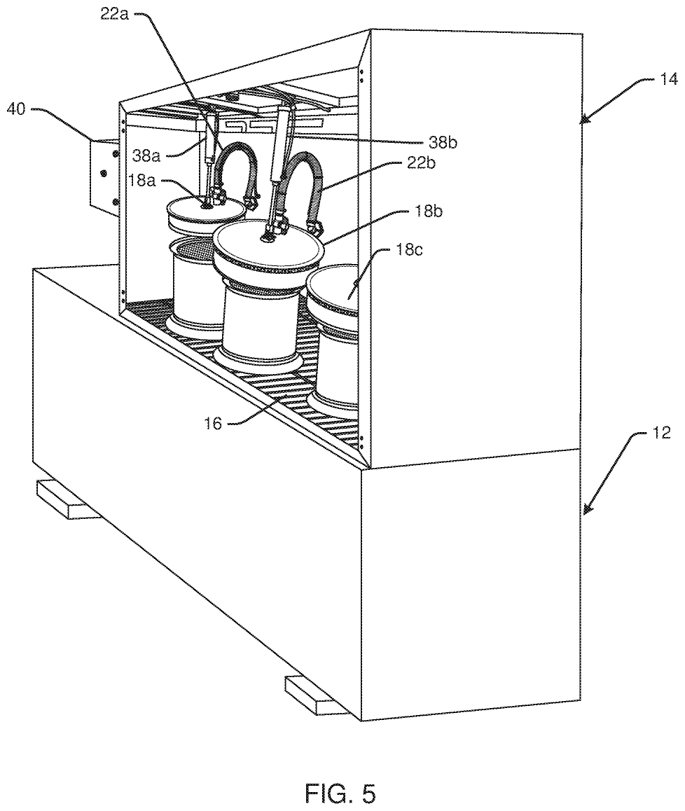

FIG. 3 is a close-up perspective view of an upper cabinet 14 of the example flush station 10. FIG. 4 is a close-up view of an example cleaning head which may be mounted in the upper cabinet of the example flush station 10. FIG. 5 is another view of the upper cabinet 14 of the example flush station 10 shown in FIG. 3, illustrating filters 1, 2, and 3 (e.g., DPF filters) to be cleaned.

The upper cabinet 14 has an opening 16 formed through a lower section of the upper cabinet 14. The upper cabinet 14 may also be equipped with a vacuum system to capture at least some airborne particulates in the upper cabinet (e.g., particulates released into the air in the upper cabinet 14 during the cleaning operation. The example flush station 10 also includes at least one cleaning head 18a-c mounted in the upper cabinet. Although three cleaning heads 18a-c are shown, one or more cleaning heads may be provided (e.g., 2, 3, 4, or more). Each cleaning head 18a-c has an anchoring attachment 20a-c (e.g., clear acrylic plate 21a-c with sealing gasket 23a-c between the plate and top edge of the filter), a cleaning solution inlet 22a-c to dispense cleaning solution, and a compressed air inlet 24a-c to dispense compressed air, as better seen in FIG. 4. In another example, the air line may be provided to air inlet 24a-c via the control arms 38a-c. In that example, control arms 38a-c may be hollow metal tubes that allow the compressed air to pass therethrough. Or separate air lines may be provided on the control arms 38a-c and need not be integrated with the control arms 38a-c.

The cleaning heads 18a-c are configured to deliver cleaning solution under pressure (e.g., via pumps). In an example, each cleaning head 18a-c (also referred to as a pump or cleaning station) is configured with a separate, individually programmable pump for delivering the cleaning solution. The pumps (not shown) may be mounted in, on, or adjacent the lower cabinet 12 and/or upper cabinet 14.

In an example, the filter flush station 10 may include redundancy. For example, a plurality of cleaning heads 18a-c may be provided, such that if one cleaning head fails (e.g., cleaning head 18a), additional cleaning heads (e.g., cleaning heads 18b and 18c) are still available to service the filters.

In an example, the lower cabinet 12 may be configured at least in part to support the upper cabinet 14. The lower cabinet 12 has an opening 26 formed through an upper section of the lower cabinet 12. A catch basin 27 is formed in the lower cabinet 12 under the opening 26 formed through the upper section of the lower cabinet 12.

Although not illustrated in FIG. 2, a screen and/or pre-filter may be provided directly under the grate, and/or filter media may be provided in the catch basin 27 to filter the spent cleaning solution before the spent cleaning solution enters the at least one settling tank (e.g., settling tanks 28a-c). Any suitable pre-filter (e.g., a filter cartridge) may be provided. Any suitable filter media may be provided (e.g., activated carbon, lava rock, etc.). The selection, amount, and positioning (e.g., in layers) of filter media may depend at least to some extent on design considerations. Example design considerations may include, but are not limited to the type of contaminant being removed, properties of the cleaning solution the contaminant is being removed from, and/or the extent to which the spent cleaning solution is to be filtered in the catch basin 27.

The lower cabinet 12 may also have at least one settling tank 28a-c. Three settling tanks 28a-c are shown in FIG. 2 (as these may be positioned on the left side of the lower cabinet 12 under lid 30 (FIG. 1). However, any number (1 or more) settling tanks 28a-c may be provided. Each settling tank 28a-c is fluidically connected (e.g., via passage 32) to the catch basin 27 to receive spent cleaning solution from the catch basin 27. The settling tanks 28a-c may be fluidically connected (e.g., via passages 32b, 32c) to one another and a main holding tank 34 (e.g., via passage 32d). The settling tanks 28a-c are configured for settling at least some or all suspended particulate matter in the spent cleaning solution prior to discharging the spent cleaning solution (e.g., for disposal and/or re-use).

In an example, the cleaned cleaning solution may be provided back to the main holding tank 34 for reuse. The main holding tank 34 may also include a suction hose with 3-stage filtration (e.g., using a replaceable filter). Thus, in an example, there are at least 12 stages of filtration before the cleaning solution is reused each time.

In an example, the lower cabinet 12 has two, one-inch drain valves at the bottom for service. One drain valve for the catch basin, and another which drains the settling tanks. The settling tanks 28a-c are designed for complete removal of the top tank, removal of deck surface where substrates are placed, and removal of a flow/water pan, so that the inside of tanks is easily accessible for cleaning.

The main tank 34 is a storage tank (e.g., separate from and connected to, or integral as part of the upper and/or lower cabinets) to contain the cleaning solution for the cleaning operation. The cleaning solution may be water, water and a detergent, or other solution selected based on the desired cleaning operation. The spent cleaning solution may be discharged and/or re-used (in the cleaning station 10 itself, and/or for another application). In an example, the water and/or cleaning solution employed in the flush cycle of the cleaning operation is a recycled closed loop system that uses a combination of filtration, filter media, lava rock, gravity, and a pre-filter that is cleanable and reusable.

In an example, each cleaning head 18a-c includes a control arm 38a-c to press the anchoring attachment 20a-c against a top portion of the filters and/or other components (e.g., filters 1a-c shown in FIG. 5) to be cleaned and maintain the filters and/or other components in place for the cleaning operation.

The cleaning station 10 may include a control system to control the cleaning operation. The cylinders that hold substrates and substrate housing in place for service uses air to maintain placement, and are operated by a control system 40. The control system may be implemented as electronics (e.g., sensors, actuators, timers, etc.) and control logic (e.g., firmware and/or software) to control the various aspects of a cleaning operation (described below).

The control panel 40 may be implemented to service, start/stop, and/or monitor the cleaning operation (e.g., based on user and/or sensor input). In an example, the control system 40 controls the on/off of individual pumps, and controls the individual solenoids to release compressed air at each station 18a-c. The cleaning solution flush and air purge are also controlled by the control system 40.

In an example, the control system 40 is operable at a physically remote location relative to the flush station (e.g., via a phone app) and/or locally at the filter flush station. The control system 40 is configured for end-user selection of a number of cleaning operation parameters. Examples of cleaning operation parameters may include, but are not limited to, a pressure for delivering cleaning solution, a duration for delivering cleaning solution, a pressure for delivering compressed air, a duration for delivering compressed air, a start time for a cleaning operation, and a stop time for the cleaning operation.

In an example, each cleaning head 18a-c may be operated by the control system 40 for cleaning a different type and/or size of filter or other component. As such, multiple cleaning heads 18a-c may be operated at any one time to clean the same and/or different types and/or sizes of filter and/or other component. By way of illustration, one cleaning head (e.g., cleaning head 18a) may be provided for filters used in light duty passenger cars or light duty trucks, while another cleaning head (e.g., cleaning head 18b) may be provided for filters used in heavy duty applications (e.g., large trucks or semis and heavy equipment). Each cleaning head 18a-c can be programmed to flush at different intervals, purge at different intervals, purge time holds at different intervals depending on the severity of blockage in the channels of filter substrate each station has flow control valves 25a-c to adjust flow depending on filter size and dimensions. As such, the same cleaning station 10 may be configured for multiple different end-uses.

The control system 40 may be implemented to provide other operations. In an example, the control panel 40 may also be implemented to adjust height of the control arms 38a-c.

In another example, the flush station 10 may be configured with a heating system to provide a kiln (e.g., in upper cabinet 14 or as a stand-alone component of the system). The kiln may be activated to fracture hardened ash and soot inside the filter. Following heat fracturing, the flush operation at the cleaning station 18a-c may be operated to flush the loosened ash and soot out of the filter.

Before continuing, it should be noted that the examples described above are provided for purposes of illustration, and are not intended to be limiting. Other devices and/or device configurations may be utilized to carry out the operations described herein.

During an example cleaning operation, the filters and/or other components to be cleaned are positioned on the grate 36 in the upper cabinet 14 and maintained in place for the cleaning operation by the cleaning head 18a-c while the cleaning solution and/or compressed air are dispensed through the filters and/or other components. The cleaning solution is forced (e.g., by pressure applied by the control system) through openings in the filters and/or other components and the cleaning solution exits from the filters and/or other components as the spent cleaning solution, during the cleaning operation, the compressed air is forced through openings in the filters and/or other components. The spent cleaning fluid is collected for processing in the lower cabinet 12 (e.g., filtration and/or settling prior to discharge and/or re-use of the cleaning solution).

An example cleaning operation uses water to fill the cavity between a sealing plate (which may be transparent for visual inspection of the filters) and the face of the DPF. After water has filled the cavity, an SL100 cleaning solution or comparable cleaning solution is pumped in, to break down and soften hardened soot and ash. When this cleaning step is complete, all water and cleaning solutions are drained, and the cleaning deck then purges the filter with compressed air, dislodging any renaming particulates inside their cell channels.

The operations shown and described herein are provided to illustrate example implementations. It is noted that the operations are not limited to any particular order. Still other operations may also be implemented.

Still further operations may include, but are not limited to, cleaning other types of substrates, or incorporating other types of cleaning solutions or cleaning mixtures into the flush station.

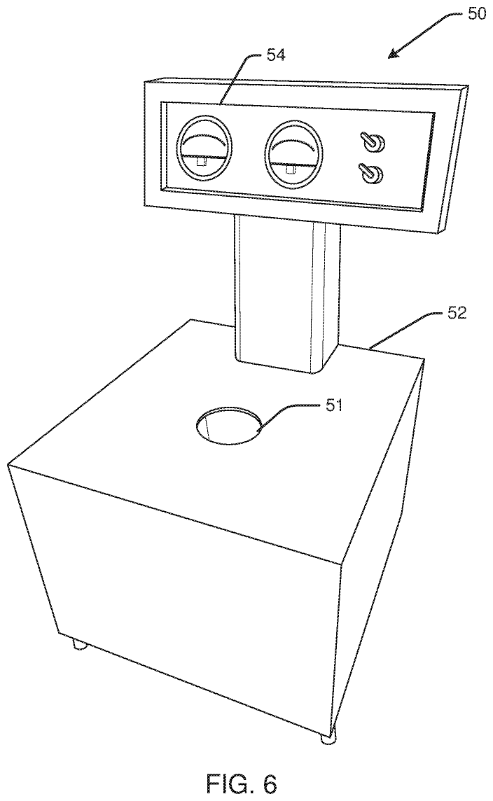

FIG. 6 is a perspective view of an example flow bench 50 (also referred to as a restriction table) which may be implemented with the flush station 10. The restriction table 50 is configured with a vacuum formed at opening 51 in deck 52 to pull air through the filters and/or other components and measure back pressure to determine percent restriction of the filters and/or other components.

The platform or deck 52 is configured to firmly press around an outer diameter of the filter. In an example, the deck 52 is made of, or includes a soft rubber or other material, allowing for a very tight seal during testing, and thus allowing for much more accurate flow results. In an example, the front deck has an integrated flow bench control panel 54 to actuate and measure (e.g., via a restriction meter) so that the end-user can determine how restricted the substrate is during the check in process, and select a corresponding cleaning operation (e.g., via control system 40).

This test may be performed before the cleaning operation, e.g., to determine parameter adjustment for the cleaning operation. For example, filters that are more clogged may require a longer cleaning duration, and/or higher pressure delivery of the cleaning solution and/or compressed air. In an example, the restriction table 50 may be provided a separate, stand-alone component. Or the restriction table 50 may be made integral as a part of the lower cabinet 12.

By way of illustration, a DPF is placed in a filter receptacle on the restriction bench over opening 51, and air is flowed through it. The percent of airflow through the DPF or substrate is measured, and serves as an approximate measure of the degree of particulate fouling within the pores of the DPF.

In an example, the restriction bench 50 can accurately measure restriction and back pressure of a DPF, allowing a user to know how much ash and soot is lodged inside cell channels of the DPF. In an example, the restriction bench has 2 gauges. A first gauge from 0 to 10 inches of mercury, and a second gauge from 10 to 60 inches of mercury (e.g., for a DPF that is excessively restricted).

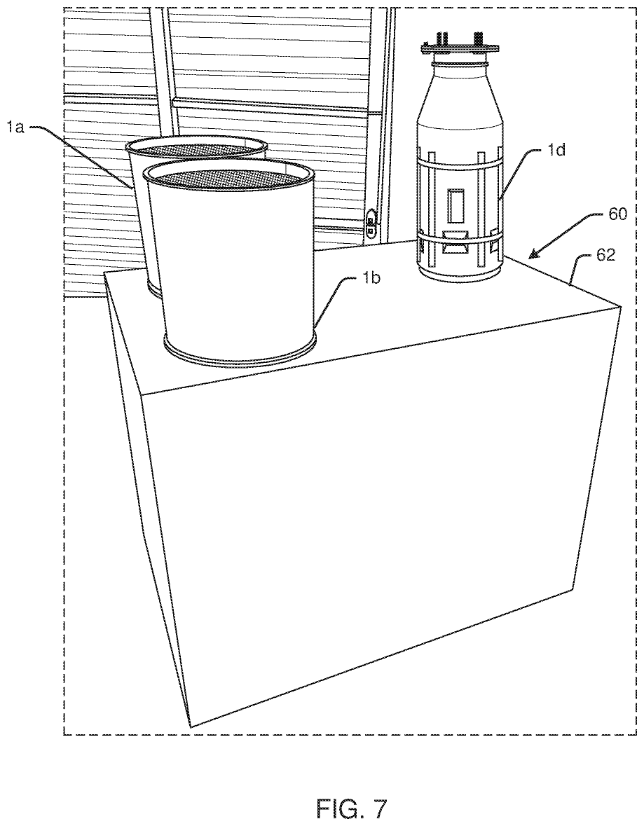

FIG. 7 is a perspective view of an example drying table 60 which may be implemented with the flush station. In an example, the drying table incorporates a high capacity blower to force air through the top of the bench 62 pores of the cleaned filters (e.g., filters 1a-b and 1d in FIG. 7). In an example, the air may also be heated. The drying table 60 itself is configured to force air through the filters and/or other components to speed evaporation during a drying operation. The drying table 60 may be provided as a separate, stand-alone component.

In an example, the drying table 60 is configured to dry multiple filters and/or other components simultaneously and/or for overlapping duration. The drying table 60 may be configured to provide a 2-4 hour drying time instead of the 24 hour drying time that might be normal under ambient conditions.

It is noted that the examples shown and described are provided for purposes of illustration and are not intended to be limiting. Still other examples are also contemplated.

1. A flush station, comprising:
an upper cabinet having an opening formed through a lower section of the upper cabinet;
at least one cleaning head mounted in the upper cabinet, the at least one cleaning head having an anchoring attachment, a cleaning solution inlet to dispense cleaning solution, and a compressed air inlet to dispense compressed air;
a lower cabinet to support the upper cabinet, the lower cabinet having an opening formed through an upper section of the lower cabinet;
a catch basin formed in the lower cabinet under the opening formed through the upper section of the lower cabinet;
at least one settling tank in the lower cabinet, the at least one settling tank fluidically connected to the catch basin to receive spent cleaning solution and particulates from the catch basin for settling at least some suspended particulate matter in the spent cleaning solution prior to discharging the spent cleaning solution; and
a grate provided at an interface between the opening formed through the lower section of the upper cabinet and the upper section of the lower cabinet, the grate providing a cleaning deck to receive filters and/or other components to be cleaned; and
wherein during a cleaning operation the filters and/or other components to be cleaned are positioned on the grate and maintained in place for the cleaning operation by the cleaning head while the cleaning solution and/or compressed air are dispensed through the filters and/or other components;
wherein during the cleaning operation, the spent cleaning fluid is collected for processing in the lower cabinet.

2. The flush station of claim 1, wherein the at least one cleaning head includes a control arm to press the anchoring attachment against a top portion of the filters and/or other components to be cleaned and maintain the filters and/or other components in place for the cleaning operation.

3. The flush station of claim 1, further comprising filter media in the catch basin to pre-filter the spent cleaning solution and at some suspended particulates before the spent cleaning solution and remaining particulates enter the at least one settling tank.

4. The flush station of claim 1, wherein during the cleaning operation, the cleaning solution is forced through openings in the filters and/or other components and the cleaning solution and particulates exits from the filters and/or other components as the spent cleaning solution and particulates.

5. The flush station of claim 1, wherein during the cleaning operation, the compressed air is forced through openings in the filters and/or other components.

6. The flush station of claim 1, further comprising a storage tank to contain the cleaning solution for the cleaning operation.

7. The flush station of claim 1, further comprising a control system to control the cleaning operation.

8. The flush station of claim 7, wherein the control system is operable at a physically remote location relative to the flush station via a phone app.

9. The flush station of claim 7, wherein the control system is operable locally at the flush station.

10. The flush station of claim 7, wherein the control system is configured for end-user selection of at least one of: a pressure for delivering cleaning solution, a duration for delivering cleaning solution, a pressure for delivering compressed air, a duration for delivering compressed air, a start time for a cleaning operation, and a stop time for the cleaning operation.

11. The flush station of claim 1, further comprising a restriction table to force air through the filters and/or other components to measure back pressure to determine percent restriction of the filters and/or other components.

12. The flush station of claim 11, wherein the restriction table is integral with the lower cabinet.

13. The flush station of claim 1, further comprising a drying table configured to force air through the filters and/or other components to speed evaporation during a drying operation.

14. The flush station of claim 1, further comprising a vacuum system in the upper cabinet to entrain airborne particulates.

15. A filter flush station, comprising:
an upper cabinet;
at least one cleaning head mounted in the upper cabinet, the at least one cleaning head having an anchoring attachment, a cleaning solution inlet to dispense cleaning solution, and a compressed air inlet to dispense compressed air;
a lower cabinet;
a catch basin formed in the lower cabinet to receive spent cleaning solution and particulates from the upper cabinet during a cleaning operation;
at least one settling tank in the lower cabinet, the at least one settling tank receiving spent cleaning solution and particulates from the catch basin for settling at least some suspended particulate matter in the spent cleaning solution and particulates prior to discharging the spent cleaning solution; and
a grate at an interface between the upper section and the lower cabinet, the grate providing a cleaning deck for filters and/or other components to be cleaned during the cleaning operation.

16. The filter flush station of claim 15, wherein the at least one cleaning head includes a control arm to press the anchoring attachment against a top portion of the filters and/or other components to be cleaned and maintain the filters and/or other components in place for the cleaning operation.

17. The filter flush station of claim 15, wherein during the cleaning operation the filters and/or other components to be cleaned are positioned on the grate and maintained in place for the cleaning operation by the cleaning head while the cleaning solution and/or compressed air are dispensed through the filters and/or other components.

18. The filter flush station of claim 15, a vacuum system in the upper cabinet to capture at least some airborne particulates.

19. The filter flush station of claim 15, further comprising filter media in the catch basin to pre-filter the spent cleaning solution and particulates before the spent cleaning solution and remaining particulates enters the at least one settling tank.

20. A filter flush station, comprising:
an upper cabinet;
at least one cleaning head mounted in the upper cabinet, the at least one cleaning head having an anchoring attachment, a cleaning solution inlet to dispense cleaning solution, and a compressed air inlet to dispense compressed air;
a vacuum system in the upper cabinet to entrain airborne particulates;
a lower cabinet;
a catch basin formed in the lower cabinet to receive spent cleaning solution and particulates from the upper cabinet during a cleaning operation;
at least one settling tank in the lower cabinet, the at least one settling tank receiving spent cleaning solution and particulates from the catch basin for settling at least some suspended particulate matter in the spent cleaning solution prior to discharging the spent cleaning solution;
a grate at an interface between the upper section and the lower cabinet, the grate providing a cleaning deck for filters and/or other components to be cleaned during the cleaning operation; and
filter media in the catch basin to pre-filter the spent cleaning solution and particulates before the spent cleaning solution and remaining particulates enter the at least one settling tank;
wherein the at least one cleaning head includes a control arm to press the anchoring attachment against a top portion of the filters and/or other components to be cleaned and maintain the filters and/or other components in place for the cleaning operation;
wherein during the cleaning operation the filters and/or other components to be cleaned are positioned on the grate and maintained in place for the cleaning operation by the cleaning head while the cleaning solution and/or compressed air are dispensed through the filters and/or other components;
wherein during the cleaning operation, the spent cleaning fluid is collected for processing in the lower cabinet.
